(19) United States
(12) Patent Application Publication
(10) Pub. No.: US 2025/0031693 A1
(43) Pub. Date: Jan. 30, 2025

(54) CHEMICAL SPRAY FOR INTRUDER DETERRENT AND RELATED METHODS

(71) Applicant: Crotega L.L.C., Crystal, MN (US)

(72) Inventors: Oliver Nichols, Jordan, MN (US); Jody Allen Crowe, Eden Prairie, MN (US)

(21) Appl. No.: 18/710,603

(22) PCT Filed: Nov. 17, 2022
(86) PCT No.: PCT/US22/80024

§ 371 Date: May 15, 2024

Related U.S. Application Data
(60) Provisional application No. 63/280,571, filed on Nov. 17, 2021.

(51) Int. Cl. A01N 25/06; A01N 25/30; A01N 37/02; A01N 37/10; A01N 37/36; A01P 17/00; F41H 9/10

(52) U.S. Cl. CPC A01N 25/06; A01N 25/30; A01N 37/02; A01N 37/10; A01N 37/36; A01P 17/00; F41H 9/10

(57) ABSTRACT

A solution for deterring intruders comprises an organic acid having a pKa of 6 or less; and water; wherein the solution has a pH between about 4.5 and about 6.5. The organic acid can have a general formula of B—A—COOH, wherein A is selected from the group consisting of a bond, substituted or unsubstituted alkyl, substituted or unsubstituted heteroalkyl, substituted or unsubstituted cycloalkyl, substituted or unsubstituted heterocycloalkyl, substituted or unsubstituted aryl, and substituted or unsubstituted heteroaryl; and wherein B is selected from the group consisting of hydrogen, substituted or unsubstituted alkyl, substituted or unsubstituted heteroalkyl, substituted or unsubstituted cycloalkyl, substituted or unsubstituted heterocycloalkyl, substituted or unsubstituted aryl, substituted or unsubstituted heteroaryl, halogen, hydroxyl, oxo, peroxy acid, amino, azido, nitro, cyano, carboxyl, carbamyl, sulfo, and mercapto.

### CROSS-REFERENCE TO RELATED APPLICATION

This application claims the priority benefit of U.S. Provisional Patent Application No. 63/280,571 filed on Nov. 17, 2021, the disclosure of which is incorporated by reference in its entirety.

### INCORPORATED BY REFERENCE

All publications and patent applications mentioned in this specification are herein incorporated by reference in their entirety, as if each individual publication or patent application was specifically and individually indicated to be incorporated by reference in its entirety.

### TECHNICAL FIELD

This disclosure relates generally to the field of non-lethal chemical deterrents, and more specifically to the field of mild chemical deterrents for civilian deployment in building security. Described herein are compositions for deterring intruders.

### BACKGROUND

In the United States of America, recent decades have revealed a tragic rise in the number of public shootings. In these events, an individual seeking to commit indiscriminate violence, often with a gun or other deadly weapon, enters a public or well trafficked space such as a school, mall, or park and remains unchallenged until law enforcement arrives, or a civilian makes a daring act of self-defense. Although any delay in the apprehension of the intruder can result in human lives being lost, the responsive use of force must balance the immediate need to terminate the violence with the risk of causing further panic or medical harm to the bystanders, some who may have chronic health vulnerabilities, who are very likely in the immediate vicinity.

Nonlethal airborne chemical weapons such as pepper spray, chemical mace, and tear gas have historically been used for reversible incapacitation of aggressive individuals and crowds. Pepper spray comprises the waxy compound capsaicin, the chemical that gives peppers their heat, suspended in an emulsifier and delivered as an aerosol. Originally developed to stop aggressive predatorial animals such as grizzly bears and mountain lions, the compound causes irritation of the eyes, nose, throat, lungs, and corresponding mucous membranes. So strong is the burning sensation that it provokes instantaneous closing of the eyes, and some cases, difficulty breathing. Chemical mace, the term “mace” now referring generally to any spray-delivered irritant or lachrymatory agent used in policing or self-defense, originally comprised phenacyl chloride (a.k.a. chloroacetophenone and CN gas) that similarly irritates mucosal membranes of the eyes and respiratory passages. In some severe reactions, phenacyl chloride can cause individuals to faint. Finally, tear gas often includes a mixture of compounds depending on the manufacturer but can include, in some variants, combinations of pepper spray, phenacyl chloride, 2-chlorobenzalmalononitrile (a.k.a., CS gas), dibenzoxazepine (a.k.a., CR gas), and bromoacetone. In addition to the irritation described above, tear gas (notably its constitutive CS gas) can cause skin irritation, excessive coughing, and vomiting and in some severe cases, chemical burns to the skin and scarring of the cornea. Additionally, some exposed to tear gas may still feel certain related health effects for days following exposure.

Despite the effectiveness of these examples for incapacitating and deterring the advance of violent individuals, their toxicity presents a strong hazard to bystanders who are almost guaranteed to be near the perpetrator. Therefore, alternative compositions that are both sufficient irritants to deter an intruder but milder in severity or more facile to reverse are needed if such tools are to be more widely employed to defend public and crowded spaces.

### SUMMARY

There is a need for new and useful compositions and methods for deterring intruders. In some embodiments, the disclosure herein provides for a solution for deterring intruders comprising: an organic acid having a pKa of 6 or less and water, wherein the solution has a pH between about 4.5 and about 6.5. In some embodiments, the solution has a pH between about 5 and about 6. In other embodiments, the solution has a pH of about 5.5 to about 5.9.

In some embodiments, the organic acid has a general formula according to Formula I: B—A—COOH (Formula I) wherein A is selected from the group consisting of a bond, substituted or unsubstituted alkyl, substituted or unsubstituted heteroalkyl, substituted or unsubstituted cycloalkyl, substituted or unsubstituted heterocycloalkyl, substituted or unsubstituted aryl, and substituted or unsubstituted heteroaryl; and wherein B is selected from the group consisting of hydrogen, substituted or unsubstituted alkyl, substituted or unsubstituted heteroalkyl, substituted or unsubstituted cycloalkyl, substituted or unsubstituted heterocycloalkyl, substituted or unsubstituted aryl, substituted or unsubstituted heteroaryl, halogen, hydroxyl, oxo, peroxy acid, amino, azido, nitro, cyano, carboxyl, carbamyl, sulfo, and mercapto. In some embodiments, when A is a bond, B is hydrogen.

In some embodiments, when A is substituted or unsubstituted alkyl, substituted or unsubstituted heteroalkyl, substituted or unsubstituted cycloalkyl, substituted or unsubstituted heterocycloalkyl, substituted or unsubstituted aryl, or substituted or unsubstituted heteroaryl, the substituted or unsubstituted alkyl, substituted or unsubstituted heteroalkyl, substituted or unsubstituted cycloalkyl, substituted or unsubstituted heterocycloalkyl, substituted or unsubstituted aryl, or substituted or unsubstituted heteroaryl group contains no more than twelve heavy atoms. In further embodiments, when A is substituted or unsubstituted alkyl, substituted or unsubstituted heteroalkyl, substituted or unsubstituted cycloalkyl, substituted or unsubstituted heterocycloalkyl, the substituted or unsubstituted alkyl, substituted or unsubstituted heteroalkyl, substituted or unsubstituted cycloalkyl, substituted or unsubstituted heterocycloalkyl group is unsaturated.

In some embodiments, when B is substituted or unsubstituted alkyl, substituted or unsubstituted heteroalkyl, substituted or unsubstituted cycloalkyl, substituted or unsubstituted heterocycloalkyl, substituted or unsubstituted aryl, or substituted or unsubstituted heteroaryl, the substituted or unsubstituted alkyl, substituted or unsubstituted heteroalkyl, substituted or unsubstituted cycloalkyl, substituted or unsubstituted heterocycloalkyl, substituted or unsubstituted aryl, or substituted or unsubstituted heteroaryl group contains no more than twelve heavy atoms. In further embodiments, when B is substituted or unsubstituted alkyl, substituted or unsubstituted heteroalkyl, substituted or unsubstituted cycloalkyl, substituted or unsubstituted heterocycloalkyl, the substituted or unsubstituted alkyl, substituted or unsubstituted heteroalkyl, substituted or unsubstituted cycloalkyl, substituted or unsubstituted heterocycloalkyl group is unsaturated. In still further embodiments, B is selected from the group consisting of: hydrogen, halogen, hydroxyl, oxo, peroxy acid, amino, azido, nitro, cyano, carboxyl, carbamyl, sulfo, and mercapto.

In some embodiments, the organic acid is a substituted or unsubstituted short chain fatty acid, and further wherein the organic acid is not unsubstituted propionic acid. In other embodiments, the organic acid is a substituted or unsubstituted dicarboxylic acid. In still other embodiments, the organic acid is a substituted or unsubstituted tricarboxylic acid. In further embodiments, the organic acid is selected from the list consisting of: acetic acid, acetylenedicarboxylic acid, aconictic acid, adipic acid, aspartic acid, azelaic acid, benzoic acid, butyric acid, isobutyric acid, citraconic acid, citric acid, cyclohexanoic acid, dioxosuccinic acid, diphenic acid, formic acid, fumaric acid, glutaconic acid, glutaric acid, glutamic acid, lactic acid, maleic acid, malic acid, malonic acid, mesaconic acid, mesoxalic acid, muconic acid, niacin, oxalic acid, phthalic acid, pimelic acid, propane 1,2,3-tricarboxylic acid, sebacic acid, sorbic acid, suberic acid, succinic acid, tartaric acid, tartronic acid, terephthalic acid, trimesic acid, valeric acid, isovaleric acid, 2-chlorosuccinic acid, 2-cyanoadipic acid, and 2-methylbutyric acid.

In some embodiments the solution further comprises a cosolvent. In further embodiments, the cosolvent is selected from the list consisting of: acetone, methanol, ethanol, n-propanol, isopropanol, glycerol, ethylene glycol, and propylene glycol. In some embodiments, the solution further comprises a base. In further embodiments, the base is selected from the list consisting of: ammonia, diethylamine, triethylamine, sodium hydroxide, potassium hydroxide, calcium hydroxide, sodium carbonate, potassium carbonate, calcium carbonate, pyridine, pyrrole, pyrrolidine, and imidazole. In some embodiments, the solution further comprises a surfactant. In further embodiments, the surfactant is selected from the list consisting of: ammonium lauryl sulfate (ALS), sodium lauryl sulfate (SLS), docusate, narrow range ethoxylates (NREs), Triton X-100, Tween 20, Tween 40, Tween 60, and Tween 80. In still further embodiments, the surfactant is alcohol ethoxylates. In some embodiments, the solution further comprises a thickener. In further embodiments, the thickener is selected from the list consisting of: alginic acid, an alginate salt, agar, pectin, and gelatin. In some embodiments, the solution further comprises a dye. In some embodiments, the solution further comprises an odorant or flavorant. In some embodiments, the solution further comprises a propellant.

In some embodiments, the disclosure herein provides for a method for deterring an intruder into a predefined space comprising: providing a solution comprising: an organic acid having a pKa of 6 or less and water, wherein the solution has a pH between about 4.5 and about 6.5; detecting an intruder; and dispersing the solution in a vicinity of the intruder. In some embodiments, the solution has a pH between about 5 and about 6. In other embodiments, the solution has a pH of about 5.5 to about 5.9. In some embodiments, the organic acid is a substituted or unsubstituted short chain fatty acid but not unsubstituted propionic acid. In further embodiments, the organic acid is selected from the list consisting of: acetic acid, acetylenedicarboxylic acid, aconictic acid, adipic acid, aspartic acid, azelaic acid, benzoic acid, butyric acid, isobutyric acid, citraconic acid, citric acid, cyclohexanoic acid, dioxosuccinic acid, diphenic acid, formic acid, fumaric acid, glutaconic acid, glutaric acid, glutamic acid, lactic acid, maleic acid, malic acid, malonic acid, mesaconic acid, mesoxalic acid, muconic acid, niacin, oxalic acid, phthalic acid, pimelic acid, propane 1,2,3-tricarboxylic acid, sebacic acid, sorbic acid, suberic acid, succinic acid, tartaric acid, tartronic acid, terephthalic acid, trimesic acid, valeric acid, isovaleric acid, 2-chlorosuccinic acid, 2-cyanoadipic acid, and 2-methylbutyric acid.

### BRIEF DESCRIPTION OF THE DRAWINGS

The foregoing is a summary, and thus, necessarily limited in detail. The above-mentioned aspects, as well as other aspects, features, and advantages of the present technology are described below in connection with various embodiments, with reference made to the accompanying drawings.

FIG. 1 illustrates one embodiment of a method for deterring an intruder using a composition as described herein.

The illustrated embodiments are merely examples and are not intended to limit the disclosure. The schematics are drawn to illustrate features and concepts and are not necessarily drawn to scale.

### DETAILED DESCRIPTION

The foregoing is a summary, and thus, necessarily limited in detail. The above-mentioned aspects, as well as other aspects, features, and advantages of the present technology will now be described in connection with various embodiments. The inclusion of the following embodiments is not intended to limit the disclosure to these embodiments, but rather to enable any person skilled in the art to make and use the contemplated invention(s). Other embodiments may be utilized, and modifications may be made without departing from the spirit or scope of the subject matter presented herein. Aspects of the disclosure, as described and illustrated herein, can be arranged, combined, modified, and designed in a variety of different formulations, all of which are explicitly contemplated and form part of this disclosure.

Disclosed herein are compositions and methods for deterring intruders. Due to rising incidents of public shootings, it can be desirable to employ a chemical spray capable of deterring or incapacitating intruders while remaining sufficiently mild to allow for easy recovery for civilians and bystanders hit with the material. In some embodiments, a building or predetermined location can be fit with an intruder deterrent system that can detect an intruder and deliver the chemical spray. However, such an application presents a challenge to the standard, preexisting weapons (e.g., pepper spray, tear gas, etc.) In various situations, the high likelihood of large groups of young children, pregnant women, elderly adults, or others with well-known health vulnerabilities in the vicinity of the intruder makes the deployment of these more toxic compounds difficult. For example, pepper spray, which can cause nausea and difficulty breathing along with its irritation of the skin and eyes, can be difficult to wash, off meaning those accidentally caught in the spray may suffer for an undue length of time, sometimes still suffering long after exposure. As described herein, an aqueous solution of mild acid, when sprayed as a mist, can provide sufficient irritation to human skin and eyes to impede the advance of an intruder yet remain palatable enough to avoid lasting effects to bystanders. Furthermore, by delivering the composition as an aqueous solution, the effects from the spray can be readily reversed with exposure to clean air and/or water to rinse away the solution thereby allowing innocents to relieve themselves of the composition's effects more quickly.

### Compositions

Described herein are compositions for deterring intruders. In many embodiments, the composition is a solution comprising an organic acid having an aqueous pKa of 6 or less and water, wherein the solution has a pH of about 4.5 to about 6.5. The solution can further comprise various additives across alternative embodiments, the additives including, but not limited to, cosolvents, bases, surfactants, thickeners, dyes, odorants, flavorants, and propellants which serve to, in various selections and combinations, adjust the pH of the solution, improve solubility of the organic acid or other compounds, improve ease of aerosolization of the solution, modulate the wettability of the solution, decrease washability of the solution, improve visual, olfactory, or gustatory recognition of the composition, and assist in the delivery of the solution etc., as described herein. As used herein, the terms “composition” and “solution” are considered equivalent and will be used interchangeably.

A wide variety of organic acids are available throughout many embodiments. By an organic acid, it should be understood to include any chemical comprising carbon atoms that functions as a Brønsted-Lowry acid. In many examples, such organic acids feature at least one carboxylic acid (—COOH) or sulfonic acid (—S(═O)₂(OH)) group, although other functional groups can sufficiently release an acidic proton in other molecules. As described herein, the organic acid (or mixture of organic acids) of the composition can feature further functional groups than just the at least one carboxylic acid or sulfonic acid group in many embodiments. These additional functional groups can include, but are not limited to, alkyl, heteroalkyl, cycloalkyl, heterocycloalkyl, aryl, heteroaryl, halogen, hydroxyl, oxo, peroxy acid, amino, azido, nitro, cyano, carboxyl, carbamyl, sulfo, mercapto, etc. groups. In certain embodiments, alkyl, heteroalkyl, cycloalkyl, heterocycloalkyl, aryl, and heteroaryl groups contain no greater than eight heavy atoms (i.e., non-hydrogen, e.g., C, N, O, S, Si, etc.) A pKa of 6 or less of the organic acid means that the compound should release an acidic proton in the chemical conditions described herein of the composition, bestowing upon the composition the desired physiological irritation.

In other embodiments, the organic acid comprises a structure according to general Formula I.

B—A—COOH (Formula I)

Wherein A is selected from the group consisting of: a bond, substituted or unsubstituted alkyl, substituted or unsubstituted heteroalkyl, substituted or unsubstituted cycloalkyl, substituted or unsubstituted heterocycloalkyl, substituted or unsubstituted aryl, and substituted or unsubstituted heteroaryl; and B is selected from the group consisting of hydrogen, substituted or unsubstituted alkyl, substituted or unsubstituted heteroalkyl, substituted or unsubstituted cycloalkyl, substituted or unsubstituted heterocycloalkyl, substituted or unsubstituted aryl, substituted or unsubstituted heteroaryl, halogen, hydroxyl, oxo, peroxy acid, amino, azido, nitro, cyano, carboxyl, carbamyl, sulfo, and mercapto. In some embodiments, when A is a bond, B is hydrogen. In some embodiments, when A is substituted or unsubstituted alkyl, substituted or unsubstituted heteroalkyl, substituted or unsubstituted cycloalkyl, substituted or unsubstituted heterocycloalkyl, substituted or unsubstituted aryl, or substituted or unsubstituted heteroaryl, the substituted or unsubstituted alkyl, substituted or unsubstituted heteroalkyl, substituted or unsubstituted cycloalkyl, substituted or unsubstituted heterocycloalkyl, substituted or unsubstituted aryl, or substituted or unsubstituted heteroaryl group contains no more than twelve heavy atoms (i.e., non-hydrogen, e.g., C, N, O, S, Si, etc). In some embodiments, when A is substituted or unsubstituted alkyl, substituted or unsubstituted heteroalkyl, substituted or unsubstituted cycloalkyl, substituted or unsubstituted heterocycloalkyl, the substituted or unsubstituted alkyl, substituted or unsubstituted heteroalkyl, substituted or unsubstituted cycloalkyl, substituted or unsubstituted heterocycloalkyl group is unsaturated.

In some embodiments, when B is substituted or unsubstituted alkyl, substituted or unsubstituted heteroalkyl, substituted or unsubstituted cycloalkyl, substituted or unsubstituted heterocycloalkyl, substituted or unsubstituted aryl, or substituted or unsubstituted heteroaryl, the substituted or unsubstituted alkyl, substituted or unsubstituted heteroalkyl, substituted or unsubstituted cycloalkyl, substituted or unsubstituted heterocycloalkyl, substituted or unsubstituted aryl, or substituted or unsubstituted heteroaryl group contains no more than twelve heavy atoms (i.e., non-hydrogen, e.g., C, N, O, S, Si, etc). In some embodiments, when B is substituted or unsubstituted alkyl, substituted or unsubstituted heteroalkyl, substituted or unsubstituted cycloalkyl, substituted or unsubstituted heterocycloalkyl, the substituted or unsubstituted alkyl, substituted or unsubstituted heteroalkyl, substituted or unsubstituted cycloalkyl, substituted or unsubstituted heterocycloalkyl group is unsaturated. In other embodiments, B is selected from the group consisting of hydrogen, halogen, hydroxyl, oxo, peroxy acid, amino, azido, nitro, cyano, carboxyl, carbamyl, sulfo, and mercapto.

In some embodiments, the organic acid is a short chain fatty acid (SCFA). SCFAs are aliphatic chains of five or fewer carbons featuring a carboxylic acid group (the carbon of the carboxylic acid group is counted towards the total carbon count). As used herein, when an SCFA is said to be “unsubstituted,” it features only its necessary carboxylic acid; when an SCFA is said to be “substituted,” it features at least one additional functional group as described herein and/or at least one C-C linkage that is unsaturated. A comprehensive list of unsubstituted SCF As include: formic acid, acetic acid, propionic acid, butyric acid, isobutyric acid, valeric acid, isovaleric acid, and 2-methylbutyric acid. All of the above unsubstituted SCFAs have an aqueous pKa of less than 6. In some embodiments, when the organic acid is an SCFA, it is not unsubstituted propionic acid.

In some embodiments, the organic acid can be a substituted SCFA. Examples of substituted SCFAs can include, but are not limited to, the various hydroxybutyric acids, 2-hydroxypropioinic acid (a.k.a., lactic acid), nitroacetic acid, etc. One of skill in the art will appreciate how certain compounds not normally associated with SCFAs can be considered “substituted SCFAs.” For example, the dicarboxylic acid adipic acid can be considered as a “carboxylic acid-substituted valeric acid” with the additional carboxyl group attached to the opposing terminal carbon. Similarly, the compound citric acid can be considered as a substituted butyric acid with an additional hydroxyl group at the third carbon and extra carboxyl groups on the third and fourth carbons from the standard “head” carbon (i.e., the carbon of the carboxylic acid) of an unsubstituted butyric acid. Other examples can include, but are not limited to, succinic acid (carboxy-substituted propionic acid), malic acid (carboxyl- and hydroxyl-substituted propionic acid), tartaric acid (carboxyl- and dihydroxyl-substituted propionic acid), benzoic acid (phenyl-substituted formic acid), and niacin (pyridine-substituted formic acid). In other embodiments, these compounds can be considered as separate categories of substituted or unsubstituted dicarboxylic acids or, more generally, as organic acids. Regardless of their categorization, one of skill in the art will appreciate that the presence of additional functional groups (e.g., carboxylic acids, hydroxyl groups, aryl groups, etc.) in the above examples can produce dramatic differences in the molecules' physical properties (e.g., pKa, solubility, vapor pressure, melting point, etc.) when compared to unsubstituted SCFAs.

In other embodiments, the organic acid is a substituted or unsubstituted dicarboxylic acid. Dicarboxylic acids are organic compounds that contain two carboxylic acid groups. These compounds can be linear or branched, saturated or unsaturated, and some can comprise an aryl or heteroaryl group in various embodiments. Common saturated and unsubstituted dicarboxylic acids include, but are not limited to, oxalic acid, malonic acid, succinic acid, glutaric acid, adipic acid, pimelic acid, suberic acid, azelaic acid, sebacic acid, etc. Unsaturated dicarboxylic acids include, but are not limited to, maleic acid, fumaric acid, acetylenedicarboxylic acid, glutaconic acid, muconic acid, citraconic acid, mesaconic acid, etc. Aromatic dicarboxylic acids can include, but are not limited to, phthalic acid, terephthalic acid, diphenic acid, etc. Additionally, dicarboxylic acids can be further substituted with one or more various functional groups at any available position. In some embodiments, the one or more substitution groups are selected from the group consisting of: alkyl, heteroalkyl, cycloalkyl, heterocycloalkyl, aryl, heteroaryl, halogen, hydroxyl, oxo, peroxy acid, amino, azido, nitro, cyano, carboxyl, carbamyl, sulfo, and mercapto. In further embodiments, the one or more substitution groups are selected from the group consisting of: halogen, hydroxyl, oxo, peroxy acid, amino, azido, nitro, cyano, carboxyl, carbamyl, sulfo, and mercapto. Examples of substituted dicarboxylic acids include, but are not limited to, tartronic acid, mesoxalic acid, malic acid, tartaric acid, aspartic acid, dioxosuccinic acid, glutamic acid, 2-chlorosuccinic acid, 2-cyanoadipic acid, etc.

In other embodiments, the organic acid is a substituted or unsubstituted tricarboxylic acid. Tricarboxylic acids are organic compounds that contain three carboxylic acid groups. These compounds can be saturated or unsaturated, include aromatic groups (i.e., aryl or heteroaryl groups), and/or are further substituted by additional functional groups in various embodiments. In some embodiments, tricarboxylic acids can be considered as a substituted dicarboxylic acid having an additional carboxy group. In some embodiments, the one or more substitution groups are selected from the group consisting of: alkyl, heteroalkyl, cycloalkyl, heterocycloalkyl, aryl, heteroaryl, halogen, hydroxyl, oxo, peroxy acid, amino, azido, nitro, cyano, carboxyl, carbamyl, sulfo, and mercapto. In further embodiments, the one or more substitution groups are selected from the group consisting of: halogen, hydroxyl, oxo, peroxy acid, amino, azido, nitro, cyano, carboxyl, carbamyl, sulfo, and mercapto. Examples of tricarboxylic acids include, but are not limited to, citric acid, aconictic acid, propane 1,2,3-tricarboxylic acid, trimesic acid, etc.

In some embodiments, the organic acid is selected from the group consisting of: acetic acid, acetylenedicarboxylic acid, aconictic acid, adipic acid, aspartic acid, azelaic acid, benzoic acid, butyric acid, isobutyric acid, citraconic acid, citric acid, cyclohexanoic acid, dioxosuccinic acid, diphenic acid, formic acid, fumaric acid, glutaconic acid, glutaric acid, glutamic acid, lactic acid, maleic acid, malic acid, malonic acid, mesaconic acid, mesoxalic acid, muconic acid, niacin, oxalic acid, phthalic acid, pimelic acid, propane 1,2,3-tricarboxylic acid, sebacic acid, sorbic acid, suberic acid, succinic acid, tartaric acid, tartronic acid, terephthalic acid, trimesic acid, valeric acid, isovaleric acid, 2-chlorosuccinic acid, 2-cyanoadipic acid, and 2-methylbutyric acid.

Some embodiments can contain two or more organic acids. Using a combination of two or more organic acids in some embodiments can yield desired physical properties, such as improved physiological irritation or solubility of one or more of the components. In various embodiments, the two acids can be present in various weight ratios. Their respective weight ratios can range from about 5:95 to about 95:5 in some embodiments. In other embodiments, their weight ratios can range from about 25:75 to about 75:25. In still further embodiments, their weight ratios can be about 50:50. A solution containing a combination of two or more organic acids can further comprises any other additives or materials as described herein.

In many embodiments, the composition comprises at least one organic acid in water to form an aqueous solution. In some embodiments, the water can be deionized, distilled, or otherwise purified to a lab-grade quality. In other embodiments, the water can be municipal tap water readily available from standard infrastructure. In certain embodiments, additional miscible cosolvents can be included to assist in the solubility of some compounds (e.g., certain organic acids) or to modify other physical properties (e.g., wettability, viscosity, melting point, freezing point, etc.). Examples of cosolvents miscible with water include, but are not limited to, acetone, methanol, ethanol, n-propanol, isopropanol, glycerol, ethylene glycol, and propylene glycol.

In many embodiments, the composition has a pH of about 4.5 to about 6.5. In other embodiments, the composition has a pH of about 5 to about 6. In still further embodiments, the composition has a pH of about 5.5 to about 5.9. The mild acidity of the solution provides the majority of the physiological irritation that deters or incapacitates an intruder when sprayed. When droplets of the composition reach the skin, the acidity can induce a distracting burning or itching sensation. Additionally, aerosolized droplets of the composition can sufficiently sting the eyes, forcing the intruder to close or wipe them. Furthermore, when inhaled, the acidity of the composition can irritate the lungs, provoking the individual to cough. However, the pH of the composition is carefully selected to be mild such that the adverse effects can be readily reversed by one or all of: washing one's skin and eyes and removal to clean air, absent the aerosolized composition. In this manner, the composition can provide substantial irritation to delay or distract an intruder while any bystanders accidently sprayed can easily cure their condition once safe.

To acquire an aqueous solution of the organic acid at a particular pH, either the acid can be accurately diluted, or an excess of the acid can be sufficiently neutralized by an added base. The excess of organic acid can be considered as a weight percentage beyond what would be needed to generate a solution of the desired pH at a chosen quantity of water by dilution alone. For example, in some embodiments, the acid can be in excess of about 5% to about 200% by weight. This means that, for the chosen quantity of water, there is about 5% to about 200% by weight extra acid over what would produce the desired pH of the solution in that chosen quantity of water. In other embodiments, the organic acid can be in excess of about 5% to about 100% by weight. In still other embodiments, the organic acid can be in excess of about 5% to about 50% by weight. This excess of organic acid can then be neutralized with the addition of a base to generate the desired pH. Examples of bases include, but are not limited to, ammonia, diethylamine, triethylamine, sodium hydroxide, potassium hydroxide, calcium hydroxide, sodium carbonate, potassium carbonate, calcium carbonate, pyridine, pyrrole, pyrrolidine, and imidazole. As used herein, the term ammonia can mean both its use as a gas or in its more common form of ammonium hydroxide.

Manufacturing the composition with the process of diluting an organic acid can simplify manufacturing costs and procedures by requiring fewer ingredients, while the use of a base to neutralize an excess of acid may further impart beneficial physical properties to the solution by the addition of the further components. In some embodiments, the presence of a base within the composition can contribute to further physiological irritation.

In some embodiments, the composition further comprises a surfactant. A surfactant is a compound the interferes with the surface tension of a liquid (e.g., water) thereby modulating some of the solution's physical properties. In many embodiments, a surfactant can be used to improve solubility of other materials in solution or improve wettability of the solution. Example surfactants include, but are not limited to, anionic surfactants (e.g., common soaps such as ammonium lauryl sulfate (ALS), sodium lauryl sulfate (SLS), and docusate), non-ionic surfactants such as narrow range ethoxylates (NREs) (including alcohol ethoxylates), alkylphenol ethoxylates (e.g., Triton X-100), and fatty acid esters of sorbitol (e.g., Tween 20, Tween 40, Tween 60, and Tween 80).

In some embodiments, the composition further comprises a thickener. Thickeners can increase the viscosity of the solution or make the solution oilier, thereby making the solution more difficult to readily wash off. While increased viscosity may decrease the ease at which the compound sprays or decrease the distance required for spraying in some embodiments, it can be helpful in other embodiments to reach a desired thickness such that the composition appropriately sticks to an intruder to induce or increase its incapacitating effects. Examples of thickeners can include alginic acid, alginate salts, agar, pectin, and gelatin.

In some embodiments, the composition further comprises a dye. The use of a dye allows for a more expedient visual recognition of the presence of the composition in the air and on persons. This can greatly contribute to the ease of which civilians, or medical personnel assisting civilians, can identify who has been sprayed and on what parts of their bodies. Example dyes include food dyes permitted by regional regulatory agencies (e.g., FD&C Red No. 40, FD&C Yellow No. 5, etc.) or another dye.

In some embodiments, the composition further comprises one or more odorants or flavorants. In these embodiments, the presence of an odorant can either serve to mask an unwanted or foul smell of the composition or contribute a foul smell to the composition to make it further distracting. Furthermore, a strong smell can allow civilians and medical personnel to readily identify areas of a building that have been sprayed as well as which civilians have been sprayed. Similarly, the presence of a flavorant in the composition can either serve to mask an unwanted flavor of the composition or further contribute a foul flavor to enhance its unpalatableness. Examples of odorants and flavorants include, but are not limited to, vanillin, various mint extracts, butanal, ethanethiol, putrescine, skatole, etc.

In some embodiments, the composition further comprises a propellant to aid in the composition's dispersal and release from certain delivery vessels (e.g., an aerosol can). In various embodiments, the propellant can be a hydrocarbon (e.g., propane, n-butane, isobutane), nitrogen, oxygen, carbon dioxide, or nitrous oxide, although any other propellants can be used in alternative embodiments (e.g., various ethers or hydrofluoroalkanes).

### Methods

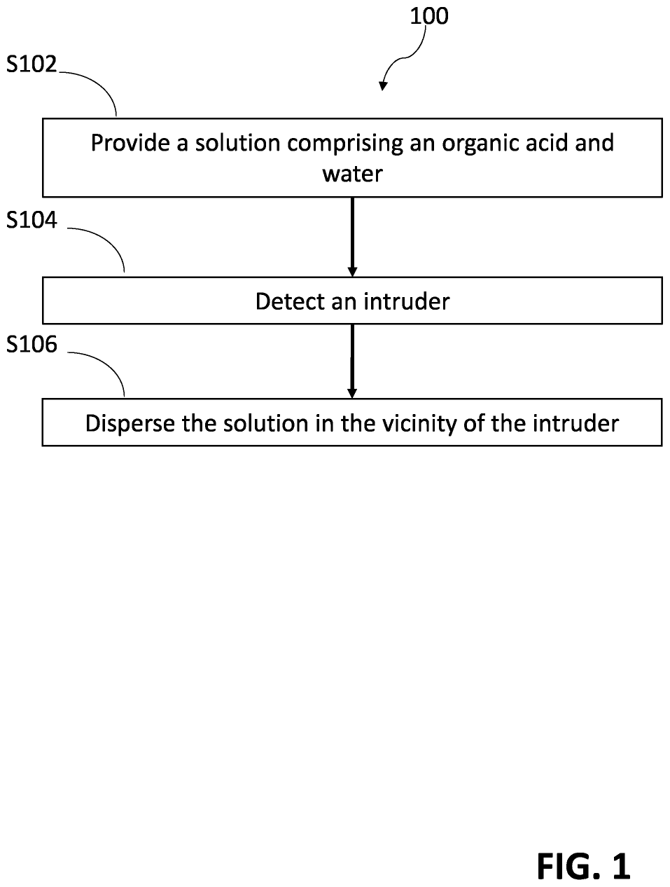

As shown in FIG. 1, a method 100 for deterring intruders of one embodiment includes providing a solution comprising an organic acid and water in block S102, detecting an intruder in block S104, and dispersing (e.g., spraying, aerosolizing, dispensing, diffusing, etc.) the solution in the vicinity of the intruder in block S106. The method 100 functions to deter or incapacitate an intruder or an aggressor, and the method is used for building or location security systems but can, additionally or alternatively, be used for any suitable applications. The method can be configured and/or adapted to function for any suitable situation wherein a chemical incapacitation or deterrence of an intruder is desired.

As shown in FIG. 1, one embodiment of the method 100 includes providing a solution comprising an organic acid and water in block S102. In many embodiments, the solution comprises an organic acid having a pKa of 6 or less and water, such that the solution has a pH between about 4.5 and about 6.5. In some embodiments, the solution has a pH between about 5 and about 6. In other embodiments, the solution has a pH between about 5.5 to about 5.9. In many embodiments, the solution is that which is described herein, and can comprise various additional components, including, but not limited to, cosolvents, bases, surfactants, thickeners, dyes, odorants, and flavorants. In some embodiments, the organic acid is selected from the group consisting of: adipic acid, acetic acid, benzoic acid, butyric acid, isobutyric acid, citric acid, formic acid, lactic acid, malic acid, sorbic acid, succinic acid, tartaric acid, valeric acid, isovaleric acid, and 2-methylbutyric acid.

As shown in FIG. 1, one embodiment of the method 100 further includes detecting an intruder in block S104. In some embodiments, the detection occurs by a human agent visually or auditorily identifying an intruder within a predetermined location. In other embodiments, the detection occurs by an automated system established within the predetermined location. The automated system can employ various sensors or detectors, including, but not limited to, cameras of various spectra, microphones, LiDAR, etc., to identify an intruder. In many embodiments, the predetermined location is the interior of a building, such as a home, a school, a hospital, an office building, a store, a restaurant, etc., but in other embodiments, the predetermined location is or includes an outdoor location such as a park, a concert venue, a patio, a sidewalk, an open garage, a warehouse, etc.

As shown in FIG. 1, one embodiment of the method 100 further includes dispersing the solution in the vicinity of the intruder in block S106. In some embodiments, the solution is dispersed from an aerosol can using a propellant. In other embodiments, the solution is dispersed as a mist by flowing the solution through an appropriate mist or spray nozzle. In some embodiments, the source of the spray of the solution is a handheld can or bottle. In other embodiments, the solution is sprayed from an automated system integrated into the infrastructure of the predetermined location. For example, a building can have one or more internal supplies of the solution (stored, e.g., within a wall or closet) that are connected via pipes and other plumbing fixtures to one or more spray nozzles located strategically throughout the predetermined location. When a detector detects an intruder, it can trigger the spray nozzles, or a subsection thereof, to release the solution. In some embodiments, the spray nozzles can spray the solution indefinitely until the supply depletes or a human terminates the action. In other embodiments, the nozzles of the automated system spray for as long as the intruder is detected in the predetermined location or subsection thereof. By the term “in the vicinity of the intruder,” it is to be understood to mean within a space sufficiently close to, but not necessarily narrowly targeted on, the intruder such that the composition reaches the intruder within about 30 seconds of the time of release in some embodiments. In other embodiments, the vicinity is close enough such that composition reaches the intruder within 15 seconds. In further embodiments, the vicinity is close enough such that the composition reaches the intruder within 5 seconds.

### PROPHETIC EXAMPLES

### Example 1

In one embodiment of the disclosure, a solution for deterring an intruder comprises acetic acid diluted in water. Acetic acid is an SCFA having molecular formula CH₃COOH and a pKa of 4.76. Sufficient water can be added to any chosen weight of acetic acid in order to dilute it to generate a solution pH of about 4.5 to about 6.5. In some embodiments, sufficient water is added to generate a solution pH of about 5.7. In certain embodiments, the solution is about 5% to about 90% water by weight. In other embodiments, the solution can comprise additional materials, including but not limited to cosolvents, surfactants, thickeners, odorants, flavorants, and propellants. The solution can then be used to spray onto an intruder as a deterrent or otherwise stored for such future use.

### Example 2

In one embodiment of the disclosure, a solution for deterring an intruder comprises an excess of butyric acid in water mixed with a quantity of ammonia (or ammonium hydroxide as described herein) to neutralize sufficient acid in order to generate a solution having a pH of about 4.5 to about 6.5. In some embodiments, the solution has a pH of about 5.7. Butyric acid is an SCFA having a pKa of 4.82. As described herein, the butyric acid can be in excess of about 5% to about 200% by weight and subsequently neutralized with ammonia to generate the desired pH. In other embodiments, the solution can comprise additional materials, including but not limited to cosolvents, surfactants, thickeners, odorants, flavorants, and propellants. The solution can then be used to spray onto an intruder as a deterrent or otherwise stored for such future use.

### Example 3

In one embodiment of the disclosure, a solution for deterring an intruder comprises benzoic acid diluted in water. Benzoic acid is an organic acid having a pKa of 4.20. Sufficient water can be added to any chosen weight of benzoic acid in order to dilute it to generate a solution pH of about 4.5 to about 6.5. In some embodiments, sufficient water is added to generate a solution pH of about 5.7. However, in some embodiments, benzoic acid's limited solubility can impede the formulation of an aqueous solution of benzoic acid. In these embodiments, a cosolvent that is both miscible in water and a better solvent for benzoic acid can be employed. For example, sufficient methanol and/or ethanol can be mixed in to allow enough benzoic acid to dissolve to generate a solution of desired pH. In other embodiments, the solution can comprise additional materials, including but not limited to cosolvents, surfactants, thickeners, odorants, flavorants, and propellants. The solution can then be used to spray onto an intruder as a deterrent or otherwise stored for such future use.

### Example 4

In one embodiment of the disclosure, a solution for deterring an intruder comprises an excess of lactic acid in water mixed with a quantity of sodium hydroxide to neutralize sufficient acid in order to generate a solution having a pH of about 4.5 to about 6.5. In some embodiments, the solution has a pH of about 5.7. Lactic acid is an organic acid having a pKa of 3.86. In some embodiments, lactic acid can be considered a substituted SCFA. As described herein, the lactic acid can be in excess of about 5% to about 200% by weight and subsequently neutralized with sodium hydroxide to generate the desired pH. Although lactic acid and sodium hydroxide have excellent solubility in water, it can be desired in certain embodiments to add a surfactant to modulate the solutions physical properties. In this embodiment, the solution further comprises ethoxylated alcohols. In other embodiments, the solution can comprise additional materials, including but not limited to cosolvents, surfactants, thickeners, odorants, flavorants, and propellants. The solution can then be used to spray onto an intruder as a deterrent or otherwise stored for such future use.

### Example 5

In one embodiment of the disclosure, a solution for deterring an intruder comprises tartaric acid diluted in deionized water. The naturally occurring enantiomer of tartaric acid, as a diprotic acid, has pKas of 2.89 and 4.40, although in other embodiments, the meso or alternative enantiomer can be used. Sufficient water can be added to any chosen weight of tartaric acid in order to dilute it to generate a solution pH of about 4.5 to about 6.5. In some embodiments, sufficient water is added to generate a solution pH of about 5.7. Because tartaric acid can chelate metal ions in solution, in some embodiments, this property can be avoided by using deionized, distilled or otherwise purified water that lacks or has negligible concentrations of metal ions. Additionally, the solution can comprise an odorant or flavorant to mask or augment the taste and scent of tartaric acid to yield either a more palatable or pungent sensation. In other embodiments, the solution can comprise additional materials, including but not limited to cosolvents, surfactants, thickeners, odorants, flavorants, and propellants. The solution can then be used to spray onto an intruder as a deterrent or otherwise stored for such future use.

### Example 6

In one embodiment of the disclosure, a solution for deterring an intruder comprises an excess of citric acid in water mixed with a quantity of calcium carbonate to neutralize sufficient acid in order to generate a solution having a pH of about 4.5 to about 6.5. In some embodiments, the solution has a pH of about 5.7. Citric acid, as a triprotic acid, has pKas of 3.13, 4.76, and 6.39. As described herein, the citric acid can be in excess of about 5% to about 200% by weight and subsequently neutralized with calcium carbonate to generate the desired pH. In this embodiment, the dissolved calcium ions then become available for chelation by the citric acid. In certain embodiments, this chelation effect can be desired. In other embodiments, the solution can comprise additional materials, including but not limited to cosolvents, surfactants, thickeners, odorants, flavorants, and propellants. The solution can then be used to spray onto an intruder as a deterrent or otherwise stored for such future use.

### Example 7

In one embodiment of the disclosure, a solution for deterring an intruder comprises cyclohexanoic acid diluted in water. Cyclohexanoic acid is an organic acid having a pKa of 4.9. Sufficient water can be added to any chosen weight of cyclohexanoic acid in order to dilute it to generate a solution pH of about 4.5 to about 6.5. In some embodiments, sufficient water is added to generate a solution pH of about 5.7. However, due to cyclohexanoic acid's limited solubility in water, the solution can further comprise a thickener with or without a cosolvent to both improve cyclohexanoic acid's solubility in increase the viscosity of the solution to allow it to better stick to an intruder when sprayed. In some embodiments, the thickener can be gelatin. In some embodiments, the additional cosolvent is ethylene glycol or n-propanol. In other embodiments, the solution can comprise additional materials, including but not limited to cosolvents, surfactants, thickeners, odorants, flavorants, and propellants. The solution can then be used to spray onto an intruder as a deterrent or otherwise stored for such future use.

### Example 8

In one embodiment of the disclosure, a solution for deterring an intruder comprises acetic acid and malic acid diluted in water. Acetic acid is an SCFA having molecular formula CH₃COOH and a pKa of 4.76, and malic acid is a dicarboxylic acid having pKas of 3.40 and 5.20. Sufficient water can be added to any chosen combined weight of the two acids in order to dilute it to generate a solution pH of about 4.5 to about 6.5. In some embodiments, sufficient water is added to generate a solution pH of about 5.7. As described herein, the acetic acid and malic acid can be present in a range of weight ratios. In other embodiments, the solution can comprise additional materials, including but not limited to cosolvents, surfactants, thickeners, odorants, flavorants, and propellants. The solution can then be used to spray onto an intruder as a deterrent or otherwise stored for such future use.

As used in the description and claims, the singular form “a”, “an” and “the” include both singular and plural references unless the context clearly dictates otherwise. For example, the term “acid” may include, and is contemplated to include, a plurality of acids. At times, the claims and disclosure may include terms such as “a plurality,” “one or more,” or “at least one;” however, the absence of such terms is not intended to mean, and should not be interpreted to mean, that a plurality is not conceived.

The term “about” or “approximately,” when used before a numerical designation or range (e.g., to define a length or pressure), indicates approximations which may vary by (+) or (−) 5%, 1% or 0.1%. All numerical ranges provided herein are inclusive of the stated start and end numbers. The term “substantially” indicates mostly (i.e., greater than 50%) or essentially all of a device, substance, or composition.

As used herein, the term “comprising” or “comprises” is intended to mean that the devices, systems, and methods include the recited elements, and may additionally include any other elements. “Consisting essentially of” shall mean that the devices, systems, and methods include the recited elements and exclude other elements of essential significance to the combination for the stated purpose. Thus, a system or method consisting essentially of the elements as defined herein would not exclude other materials, features, or steps that do not materially affect the basic and novel characteristic(s) of the claimed disclosure. “Consisting of” shall mean that the devices, systems, and methods include the recited elements and exclude anything more than a trivial or inconsequential element or step. Embodiments defined by each of these transitional terms are within the scope of this disclosure.

The examples and illustrations included herein show, by way of illustration and not of limitation, specific embodiments in which the subject matter may be practiced. Other embodiments may be utilized and derived therefrom, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A solution for deterring intruders comprising:
an organic acid having a pKa of 6 or less; and
water;
wherein the solution has a pH between about 4.5 and about 6.5.

2. (canceled)

3. The solution of claim 1, wherein the solution has a pH of about 5.5 to about 5.9.

4. The solution of claim 1, wherein the organic acid has a general formula according to Formula I:
B—A—COOH (Formula I)
wherein A is selected from the group consisting of a bond, substituted or unsubstituted alkyl, substituted or unsubstituted heteroalkyl, substituted or unsubstituted cycloalkyl, substituted or unsubstituted heterocycloalkyl, substituted or unsubstituted aryl, and substituted or unsubstituted heteroaryl; and
wherein B is selected from the group consisting of hydrogen, substituted or unsubstituted alkyl, substituted or unsubstituted heteroalkyl, substituted or unsubstituted cycloalkyl, substituted or unsubstituted heterocycloalkyl, substituted or unsubstituted aryl, substituted or unsubstituted heteroaryl, halogen, hydroxyl, oxo, peroxy acid, amino, azido, nitro, cyano, carboxyl, carbamyl, sulfo, and mercapto.

5. The solution of claim 4, wherein when A is a bond, B is hydrogen.

6. The solution of claim 4, wherein when A is substituted or unsubstituted alkyl, substituted or unsubstituted heteroalkyl, substituted or unsubstituted cycloalkyl, substituted or unsubstituted heterocycloalkyl, substituted or unsubstituted aryl, or substituted or unsubstituted heteroaryl, the substituted or unsubstituted alkyl, substituted or unsubstituted heteroalkyl, substituted or unsubstituted cycloalkyl, substituted or unsubstituted heterocycloalkyl, substituted or unsubstituted aryl, or substituted or unsubstituted heteroaryl group contains no more than twelve heavy atoms.

7. The solution of claim 4, wherein when A is substituted or unsubstituted alkyl, substituted or unsubstituted heteroalkyl, substituted or unsubstituted cycloalkyl, substituted or unsubstituted heterocycloalkyl, the substituted or unsubstituted alkyl, substituted or unsubstituted heteroalkyl, substituted or unsubstituted cycloalkyl, substituted or unsubstituted heterocycloalkyl group is unsaturated.

8. The solution of claim 4, wherein when B is substituted or unsubstituted alkyl, substituted or unsubstituted heteroalkyl, substituted or unsubstituted cycloalkyl, substituted or unsubstituted heterocycloalkyl, substituted or unsubstituted aryl, or substituted or unsubstituted heteroaryl, the substituted or unsubstituted alkyl, substituted or unsubstituted heteroalkyl, substituted or unsubstituted cycloalkyl, substituted or unsubstituted heterocycloalkyl, substituted or unsubstituted aryl, or substituted or unsubstituted heteroaryl group contains no more than twelve heavy atoms.

9. The solution of claim 4, wherein when B is substituted or unsubstituted alkyl, substituted or unsubstituted heteroalkyl, substituted or unsubstituted cycloalkyl, substituted or unsubstituted heterocycloalkyl, the substituted or unsubstituted alkyl, substituted or unsubstituted heteroalkyl, substituted or unsubstituted cycloalkyl, substituted or unsubstituted heterocycloalkyl group is unsaturated.

10. The solution of claim 4, wherein B is selected from the group consisting of: hydrogen, halogen, hydroxyl, oxo, peroxy acid, amino, azido, nitro, cyano, carboxyl, carbamyl, sulfo, and mercapto.

11. The solution of claim 1, wherein the organic acid is a substituted or unsubstituted short chain fatty acid, and further wherein the organic acid is not unsubstituted propionic acid.

12. The solution of claim 1, wherein the organic acid is a substituted or unsubstituted dicarboxylic acid.

13. The solution of claim 1, wherein the organic acid is a substituted or unsubstituted tricarboxylic acid.

14. The solution of claim 1, wherein the organic acid is selected from the group consisting of: acetic acid, acetylenedicarboxylic acid, aconictic acid, adipic acid, aspartic acid, azelaic acid, benzoic acid, butyric acid, isobutyric acid, citraconic acid, citric acid, cyclohexanoic acid, dioxosuccinic acid, diphenic acid, formic acid, fumaric acid, glutaconic acid, glutaric acid, glutamic acid, lactic acid, maleic acid, malic acid, malonic acid, mesaconic acid, mesoxalic acid, muconic acid, niacin, oxalic acid, phthalic acid, pimelic acid, propane 1,2,3-tricarboxylic acid, sebacic acid, sorbic acid, suberic acid, succinic acid, tartaric acid, tartronic acid, terephthalic acid, trimesic acid, valeric acid, isovaleric acid, 2-chlorosuccinic acid, 2-cyanoadipic acid, and 2-methylbutyric acid.

15. The solution of claim 1, further comprising a cosolvent, wherein the cosolvent is selected from the group consisting of: acetone, methanol, ethanol, n-propanol, isopropanol, glycerol, ethylene glycol, and propylene glycol.

16. (canceled)

17. (canceled)

18. The solution of claim 1, further comprising a base, wherein the base is selected from the group consisting of: ammonia, diethylamine, triethylamine, sodium hydroxide, potassium hydroxide, calcium hydroxide, sodium carbonate, potassium carbonate, calcium carbonate, pyridine, pyrrole, pyrrolidine, and imidazole.

19. (canceled)

20. The solution of claim 1, further comprising a surfactant, wherein the surfactant is selected from the group consisting of: ammonium lauryl sulfate (ALS), sodium lauryl sulfate (SLS), docusate, narrow range ethoxylates (NREs), Triton X-100, Tween 20, Tween 40, Tween 60, and Tween 80.

21. The solution of claim 1, further comprising a surfactant, wherein the surfactant is alcohol ethoxylates.

22. (canceled)

23. The solution of claim 1, further comprising a thickener, wherein the thickener is selected from the group consisting of: alginic acid, an alginate salt, agar, pectin, and gelatin.

24. The solution of claim 1, further comprising a dye, an odorant, a flavorant, or a combination thereof.

25. (canceled)

26. The solution of claim 1, further comprising a propellant.

27.-31. (canceled)
